(19) United States
(12) Patent Application Publication
(10) Pub. No.: US 2018/0363564 A1
(43) Pub. Date: Dec. 20, 2018

(54) HYBRID POWER OR THRUST GENERATOR AND VEHICLE INCLUDING SUCH A GENERATOR

(71) Applicant: Airbus SAS, Blagnac (FR)

(72) Inventor: Jean-Francois GENESTE, Toulouse (FR)

(21) Appl. No.: 16/060,305

(22) PCT Filed: Dec. 7, 2016
(86) PCT No.: PCT/FR2016/053239

§ 371 Date: Jun. 7, 2018

(30) Foreign Application Priority Data
Dec. 8, 2015 (FR) 1562022

(51) Int. Cl. F02C 7/32; B64D 27/24; F01D 15/10; F02G 1/043; F02K 5/00; H02K 7/18

(52) U.S. Cl. CPC F02C 7/32; B64D 27/24; F01D 15/10; B64D 2027/026; F02K 5/00; H02K 7/1823; F02G 1/0435

(57) ABSTRACT

A hybrid power or thrust generator including at least one thermodynamic turbine engine and at least one electric power generator. An electric power generator is electrically connected to at least one electric motor, mechanically and rotatably coupled to one or more rotating portions of the thermodynamic turbine engine, and the electric power generator operates simultaneously with the thermodynamic engine so as to supply the electric motor(s) to reduce the power drawn from the turbines of the thermodynamic turbine engine in operation. The electric power generator may comprise a thermoacoustic engine driving a linear electric alternator. The generator is advantageously implemented in a vehicle, such as an aircraft.

### CROSS-REFERENCES TO RELATED APPLICATIONS

This application claims the benefit of the French patent application No. 1562022 filed on Dec. 8, 2015, the entire disclosures of which are incorporated herein by way of reference.

### FIELD OF THE INVENTION

The invention belongs to the domain of the generation of power or thrust.

More particularly, the invention relates to a hybrid power or thrust generator combining on one generator the use of hydrocarbon fuels and electricity in the generation of power or thrust.

More particularly, the invention relates to a hybrid generator suitable for onboard applications in which the criteria for performance, mass and reliability are particularly critical, as, for example, for aircraft.

### BACKGROUND OF THE INVENTION

The generation of power or thrust, in particular in the domain of onboard applications, more often than not uses Carnot cycle heat engines implementing as energy source the heat resulting from the combustion of fossil fuels, such as kerosene in the case of aircraft.

Awareness of the progressive depletion of fossil fuels and also of their harmful effects on the environment today leads the designers of power generators for onboard applications to seek solutions based on the use of electrical energy.

Although the use of electrical energy on machines permanently on the ground poses no particular problems because of an electrical energy supply through conductive cables whose lengths and masses are not technically and financially insurmountable constraints, the difficulties are of another order of magnitude on onboard applications.

Even for surface vehicles, electrical propulsion is faced with the current limits of capacity for storing electrical energy on a vehicle, which, irrespective of the cost of the batteries or other storage means, drastically limits their autonomy or radius of action.

The solution proposed today so as to increase the autonomy of electric land vehicles is to double, on these vehicles, the electric propulsion chain with a conventional propulsion chain with a heat engine using fossil fuels. This hybridization solution is obviously not satisfactory, since in the search for an improvement through electric propulsion, a much more complex, heavier and more costly propulsion architecture is obtained, which finally consumes fossil fuels as soon as electric autonomy is exceeded, even for recharging the electric accumulators.

This type of vehicle, known in particular in the field of motor vehicles, is considered as hybrid in the sense that it is propelled by two energy modes, electric and heat, used alternately.

For airborne applications, the electric propulsion solution is also envisaged, but the constraints prove to be even more severe than for surface vehicles.

In particular, the mass of the propulsion system, its operating safety and its reliability are essential dimensioning criteria to take into account.

To illustrate the difficulties to which the designers of aircraft with electric propulsion are exposed, the case of a modern passenger transport aircraft of average dimensions can be considered, for example, a twinjet medium-haul aircraft with a takeoff mass of 80000 kg and transporting between 150 and 200 passengers to a Mach number of 0.78 in cruise, for example, an Airbus A320®.

In order to ensure the propulsion of such an aircraft, it is necessary to dispose of a power of 30 MW, which translates, for example, into electrical currents of 3 kA at a voltage of 10 kV. Generating and transporting such electric currents in the structure of an aircraft transporting passengers is obviously not without posing problems of technical complexity, mass and safety, which are not resolved by using superconductors having to be kept in strict temperature conditions.

It is also necessary to ensure the storage of the energy on board the aircraft, which can be achieved with accumulator batteries, or which can be achieved in the form of hydrogen for supplying fuel cells. However, current technology does not allow, with acceptable mass and reliability, the required energy to be stored with the safety constraints imposed for a commercial flight.

In the field of aeronautics, it has also been proposed, in the document GB 2526611, to produce a thermodynamic engine capable of operating in a high speed ramjet mode and in a “low” speed turbojet mode. In the proposed solution, the compressor stages of the air intake diffuser used in the low speed turbojet mode are rotably actuated by electric motors, powered by batteries or fuel cells, which replace the turbine stages of conventional turbojets.

In such an engine, the operation is hybrid in that it includes two independent operating modes, the “ramjet” mode and the “turbojet” mode, the turbojet mode being a thermodynamic engine with no turbine, which in this case additionally needs an electrical source in order to operate.

A generator is also known from the document US 2004/065086, which uses a conventional thermodynamic turbine engine including a compressor, a combustion chamber, in which a fuel is burned with air, and a turbine of a rotating assembly.

In this generator, the shaft of the rotating assembly is coupled with a turbine operating with a working fluid in closed circuit retrieving heat from the operation of the turbine in open circuit. An electrical motor/alternator, used to set in rotation the rotating portion to start the turbine, used as an electrical generator when the turbine has started, and a mechanical power take-off coupled to the rotating shaft are also assembled on the rotating shaft common to these two interlinked systems.

The generator is considered here as hybrid in the sense that it produces mechanical and electrical energy, but without any particular complementarity in the operation of the generator.

Thus, in particular for onboard applications, at least until the technologies needed to provide totally electric propulsion become available, a need exists today to develop hybrid generation solutions in which the sources of power used for propulsion combine their contributions by making best use of the abilities of each one to produce useful energy for propulsion by combining the advantages of each source, in particular in terms of propulsive performance and of the operational requirements expected of a propulsion system, in particular for a vehicle, and which stands out from the existing hybrid systems so as to compensate for the inadequacies of the existing electric propulsion systems, and without leading to an accumulation of the disadvantages of the two implemented modes, thermal and electrical.

### SUMMARY OF THE INVENTION

The present invention brings a solution to the problems of the prior art by means of a hybrid power or thrust generator combining a conventional turbine engine powered by a fuel in liquid or gaseous phase and an electric power generator supplying energy to an electric motor mechanically coupled to the turbine engine.

According to the invention, a hybrid power or thrust generator includes at least one thermodynamic turbine engine and at least one electric power generator.

The electric power generator(s) is/are electrically connected to the electric motor(s), and each electric motor is mechanically and rotably coupled to at least one rotating portion of a thermodynamic turbine engine and the electric power generator(s) is/are in simultaneous operation with the thermodynamic turbine engine so as to supply the electric motor(s) to reduce the power drawn from at least one turbine of the thermodynamic turbine engine in operation.

Thus, in the hybrid generator, energy is introduced in mechanical form, which is added directly to the power of the thermodynamic engine, this mechanical power having an electrical origin, which can be deported and is more easily variable both in its localization and in its mode of generation.

In an embodiment, the electric power generator(s), at least one of them, include(s) at least one thermoacoustic engine driving a linear electric alternator. This way, electric power is generated, which can be produced by a heat source resulting from the combustion of a fuel, or another heat source, by means of a motor, which is silent and reliable since not including moving parts other than the pistons and cores associated with a linear electric motor for generating an acoustic wave in the thermoacoustic engine, and associated with a linear electric alternator for generating the electrical energy from the amplified acoustic wave in the thermoacoustic engine.

In an embodiment, at least one cold source of a thermoacoustic engine implements a fuel also used by the thermodynamic turbine engines and/or used by the thermoacoustic engines.

In a particular embodiment, the fuel is a cryogenic fuel stored in the liquid state at a temperature lower than 120 K, for example, cryogenic liquid methane

A cold source is thus obtained of substantially constant character, and which, in the case of a cryogenic fuel, makes it possible to increase the output of the thermoacoustic engine by lowering the temperature of the cold source to a temperature substantially lower than the ambient temperature. Furthermore, the fuel, initially in the liquid state, can be brought to the gaseous state, or to a temperature close to its gasification, by the heat that is supplied to it in the cold heat exchanger(s) of the thermoacoustic engine(s), which simplifies its injection into the burners and assists total combustion.

In an embodiment, at least one heat source of at least one thermoacoustic engine uses, for at least a portion of the quantity of heat supplied to one or more of the hot heat exchangers of the thermoacoustic engine, the combustion of a fuel that is also used to supply the thermodynamic turbine engine(s). This way, it is only necessary to have a single type of fuel to supply the hybrid generator.

In an embodiment, at least one heat source of at least one thermoacoustic engine uses, for at least a portion of the quantity of heat supplied to one or more of the hot heat exchangers of the thermoacoustic engine concerned, a quantity of heat drawn from one or more of the thermodynamic turbine engines at a combustion chamber and/or turbine stages of the engines concerned. Advantage is thus taken of a quantity of heat produced by the thermodynamic turbine engine(s) to produce electrical energy without it being necessary to install specific electric generators on the thermodynamic turbine engines.

In an embodiment, the electric power generator is dimensioned to deliver electric power equal to or greater than 10% of a thermodynamic power of a continuous operating rpm in service of at least one thermodynamic turbine engine of the hybrid generator.

Advantageously, the electric power generator is also dimensioned to deliver electric power less than or equal to a thermodynamic power of a continuous operating rpm in service of at least one thermodynamic turbine engine of the hybrid generator.

Thus, at least in the domains of continuous use of the hybrid generator, principally a cruise rpm of a vehicle using the hybrid generator as a means of propulsion, the portion of the electric power supplied is significant without replacing the portion of the power supplied by the thermodynamic turbine engine, which remains predominant and avoids too large a size of thermoacoustic generator. In particular, when the propulsion of a vehicle, an aircraft for example, is provided by thermodynamic turbine engines used as turbojets or turbo-engines, these will advantageously have minimum dimensions for generating the flux necessary for propulsion that an increase in the electric supply via the electric power source will not make it possible to reduce effectively in particular in terms of propulsive performance.

In an embodiment of the hybrid generator, the thermodynamic turbine engine, if applicable several thermodynamic turbine engines implemented in the hybrid generator, is/are arranged as turbojet(s) or as turboprop unit(s). In this configuration, it is possible to implement the hybrid generator on jet aircraft, or on aircraft with propellers driven by turbine engines, without it being necessary to call into question the architecture of known jet aircraft, the electric power generators being advantageously arranged in the aircraft structure without any major impact on aerodynamic performance.

The invention also relates to a vehicle including at least one hybrid generator such as that described above and implemented as a main propulsion device. The vehicle thus takes advantage of the disclosed benefits of the hybrid generator of the invention.

In an embodiment, at least one electric power generator of the at least one hybrid generator is implemented as a main source of electrical energy of equipment of the vehicle. It is thus possible when designing the vehicle to eliminate the auxiliary power units and electric generators mechanically coupled to the thermodynamic turbine engines, solution without disadvantage because the autonomous operation of the electric power source is possible without implementing the thermodynamic turbine engine.

In an embodiment, the vehicle includes at least two hybrid generators, and the use of at least one electric power generator of each of the hybrid generators can, through reconfigurations of a system of distribution of the electrical energy produced by the electric power generators, be switched towards one or other of the thermodynamic turbine engines of each of the hybrid generators, the switching affecting all or some of the electric power.

This way, failure configurations can be remedied by sharing the electrical energy of an electric power generator between two or more thermodynamic turbine engines, for example in the event of failure of an electric power generator, or by supplying the electrical energy of two electric power generators to one or more thermodynamic turbine engines, for example in the event of failure of a thermodynamic engine, and in a general manner to share the electrical energy produced by all of the operational electric generators among all of the operational thermodynamic turbine engines.

The invention applies, in particular, to the case of an aircraft, for example a helicopter or an airplane.

In an embodiment, the electric power generator of each of the hybrid generators includes a thermoacoustic engine installed in a fuselage of the aircraft, or in the wings, or in streamlined spaces of the aircraft structure.

The elongated shape of the fuselage lends itself well in this case to the elongated shape of the thermoacoustic engine, whose continuous operation relatively close to the passengers is compatible with its inherently silent operation.

The elongated spanwise shape of the wings also proves to be useful provided there is a sufficient space without fuel and the use of streamlined spaces having a geometry suitable for limiting impacts on aerodynamic drag makes it possible to have dedicated spaces for the thermoacoustic engines without penalizing the other spaces of the structure used in particular for passengers, cargo or fuel, and facilitating the segregation between the different components of the hybrid generator and of the other components of the systems of the aircraft.

### BRIEF DESCRIPTION OF THE DRAWINGS

The description and drawings of an embodiment and implementation example of the invention will makes it possible better to understand the aims and advantages of the invention. It is clear that this description is given as an example, and has no limitative character.

In the figures:

FIG. 1 illustrates a twinjet aircraft of the medium-haul type including two hybrid generators assembled as turbojets, the detail (a) of the figure illustrating a hybrid generator diagram;

FIG. 2 diagrammatically shows an example of a thermoacoustic electric generator suited to the electric power source.

### DETAILED DESCRIPTION OF THE PREFERRED EMBODIMENTS

Parts on the drawings that illustrate elements having the same function, even of different compositions, are identified by the same reference.

The elements illustrated on the different figures and the different elements on a single figure are diagrammatic illustrations and are not necessarily illustrated to the same scale.

In particular, elements of details considered to be useful or important in the context of the invention are highly magnified as required, compared with the other drawing elements, in the interest of clarity of the illustrations.

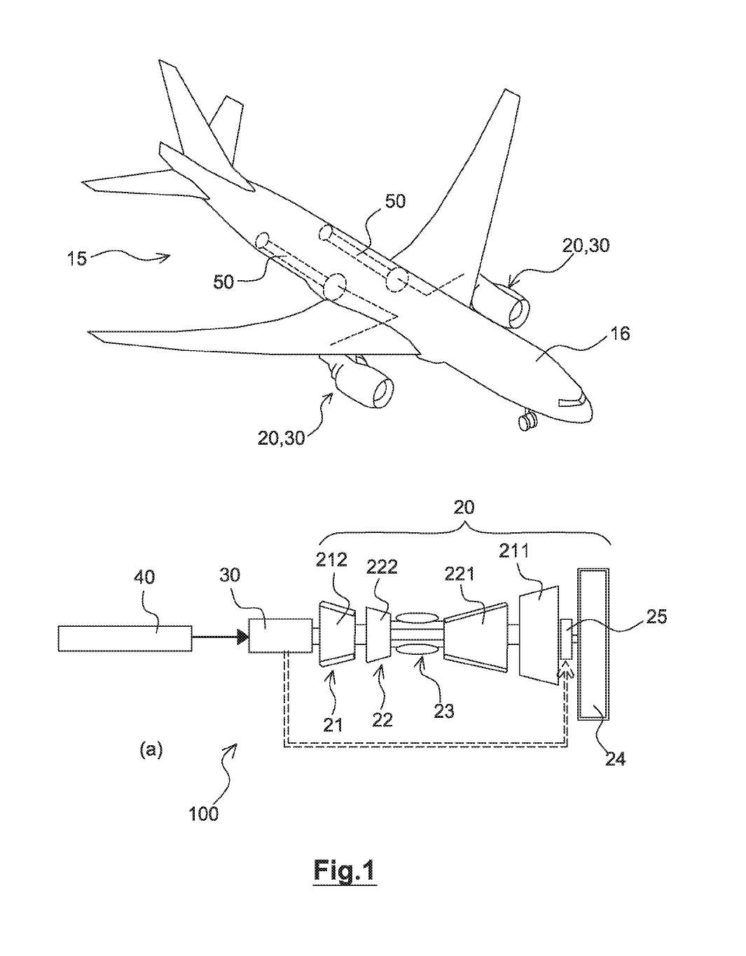

FIG. 1 diagrammatically shows an embodiment of a hybrid generator 100, detail (a) of FIG. 1, according to the invention, and an example of which is described in detail with reference, non-limitative, to an application to the propulsion via turbojets of an aircraft 15.

In the example of FIG. 1, the case is taken of the turbojet application as a thermodynamic turbine engine 20.

The thermodynamic turbine engine 20 schematized on FIG. 1 is that of a twin-spooled bypass engine. These characteristics, which are advantageous in the context of a search for global propulsive performance of a subsonic civil aircraft are, however, not indispensable to the implementation of a hybrid generator architecture according to the invention, as will be understood from the continued description.

The schematized thermodynamic turbine engine 20 includes, in a conventional manner

a high pressure rotating body 22 including in turn a high pressure compressor 221 rotably driven by a high pressure turbine 222;

a low pressure rotating body 21 including in turn a low pressure compressor 211 rotably driven by a low pressure turbine 212;

a combustion chamber 23 situated between a zone of compressors and a zone of turbines, so as to supply, via the combustion of a fuel with oxygen from the air, the energy needed by the turbines to drive the compressors and to produce power or, as here, useful thrust;

a large diameter compressor 24, or fan, rotably driven by the low pressure rotating body, if necessary via a reducing gear 25.

It should be noted that the thermodynamic output of such an engine depends on the compression efficiency achieved by the compressor stages 211, 221, for which a temperature T1 of the gas at compressor intake must be as low as possible and depends on the efficiency of the pressure reduction achieved by the turbine stages 222, 212, which in contrast require a temperature T4 of the gas, heated in the combustion chamber 23, at turbine intake, as high as possible so as to improve the thermodynamic performance of the jet.

The hybrid generator of FIG. 1 also includes an electric motor 30 arranged rotably coupled to at least one of the rotating bodies and/or to the stage of the large diameter compressor 24, for example via the reducing gear 25.

According to this arrangement, energy is supplied in mechanical form to at least one of the rotating assemblies, which results, via a reduction of the power drawn from the turbine(s) concerned to supply the energy needed by the compressors, in disposing of useful energy of the hybrid generator 100 in the form of thrust, increased compared with the operation of the single thermodynamic turbine engine.

In order to supply the electrical energy needed by the electric motor 30, the hybrid generator 100 includes at least one electric power source 40.

It should be noted that according to this arrangement of the hybrid generator 100 compared with totally electrical solutions or existing hybrid solutions, the operation of the thermodynamic turbine engine 20 and that of the electric motor 30 are simultaneous and not alternating, and are complementary, the effect of which is to reduce the power needed by each of the two sources of power generation, which are the thermodynamic engine and the electric power generator 40.

This simultaneity of operation thus makes it possible to reduce the mass and the dimensions of both the thermodynamic engine and the electric motor, and this without necessarily abandoning the possibility of alternating operation of both the thermodynamic engine and the electric motor as sole means of producing power or thrust, whether this alternating operation is implemented in a normal configuration or in a degraded configuration in the event of a failure on one of the thermodynamic engines or electric motors.

The source(s) of electric power 40 can be of any kind, in particular sources in which the electrical energy is stored in electric accumulator batteries or in super capacitors, or can consist in electric generators such as, for example, the auxiliary power units known on aircraft.

However, the implementation of such electric power sources, possible in the invention, remains constraining because of the present limitations for sources for storing electrical energy, limitations already disclosed previously, and because of unfavorable energy output of the conventional auxiliary power units, which use fuel of the same type as that used for the thermodynamic turbine engine 20, the implementation not providing any advantage in terms of energy output.

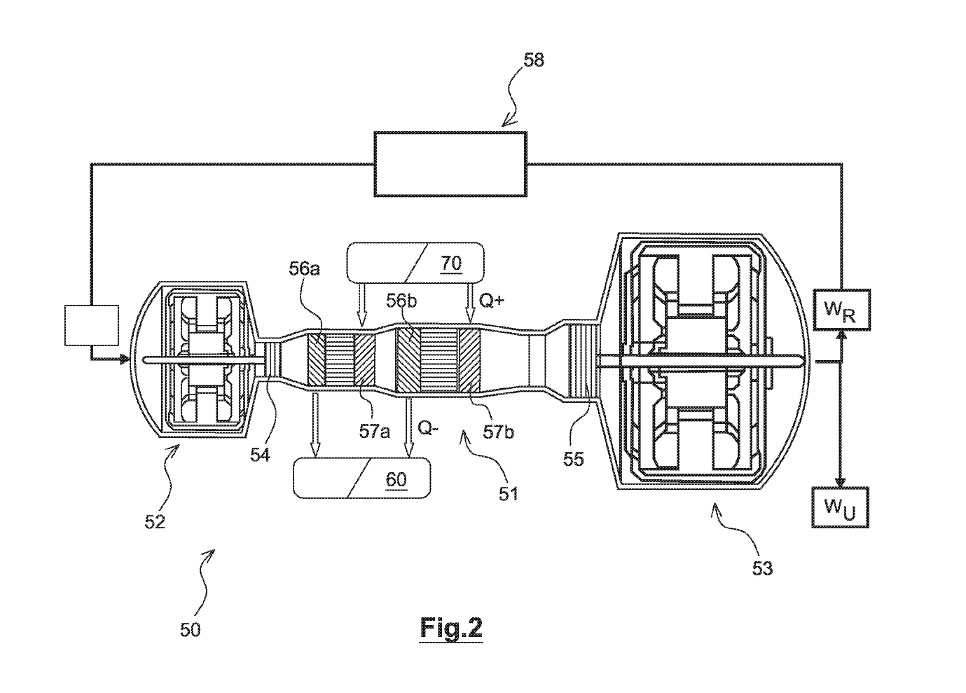

Advantageously, the hybrid generator 100 of the invention includes at least one electric power source 40 including a thermoacoustic generator 50, an example of which is diagrammatically illustrated on FIG. 2.

Thermoacoustic engines are known. Their operation is based on the thermodynamic cycle of a fluid in a closed cycle Stirling engine, but in which the displacement of the fluid ensuring the transport of heat energy is ensured by acoustic waves in place of conventional mechanical pistons. The operation of such a thermoacoustic engine is described, for example, in the French patent application published under number FR 297 1552.

In the case of the thermoacoustic generator 50 of the invention, the thermodynamic cycle is achieved in a chamber 51 including at a first end an excitation piston 54 generating an initial acoustic wave and including at a second end a power piston 55 displaced by the amplified acoustic wave; the power piston actuates a linear electric alternator 53.

The thermoacoustic generator 50 includes at least one cell including, in a manner known in thermoacoustic engines, a cold heat exchanger 56a, 56b, which transfers heat Q− to a cold source 60, a hot heat exchanger 57a, 57b, which takes heat Q+ from a heat source 70 to a regenerator stage situated between the cold and hot heat exchangers.

The thermoacoustic generator 50 can include several cells arranged between the first end and the second end of the chamber 51, and can implement one or more cold sources and/or one or more heat sources. In the example illustrated on FIG. 2, the chamber 51 includes two cells and the excitation piston 54 is actuated by a linear electric motor 52 powered by an electric feedback loop 58 formed between the linear electric alternator 53 and the linear electric motor, the electric power produced by the linear electric alternator being shared between a delivered working power WU and a return power WR to the electric feedback loop.

The implementation of the thermoacoustic generator 50 as a supply source of electric energy in the hybrid generator 100 offers several advantages.

A thermoacoustic generator 50 makes it possible to produce electric power with better output than a turbine engine because in the absence of moving parts in the hot sections, the temperatures implemented in the hot heat exchanger 57a, 57b can reach much higher values than in the case of a turbine, and can thus reach thermodynamic output values of 70% for a global output of more than 50% (taking account of the efficiency of the alternators), while the output values obtained by the turbines of engines reach 40% with difficulty.

Furthermore, the thermoacoustic generator 50 operates silently.

The thermoacoustic generator 50 is insensitive to the value of the atmospheric pressure and therefore delivers power independently of altitude.

The reliability of a thermoacoustic generator can, because of the absence of moving parts apart from the linear movements of the pistons of the engine and of the electric alternator, exceed 20000 hours of MTBF (mean time between failures), which makes it a disruptive element in the propulsion chain.

The heat source 70 can implement the combustion of the same fuel as the engine 20, the fuel can be used as cold source before being burned by the thermoacoustic generator or by the thermodynamic turbine engine.

In the example disclosed previously of a medium-haul aircraft of 80000 kg takeoff weight, a thermoacoustic generator 50 delivering 500 kW of electrical energy is used advantageously.

Such power may appear low compared with the power developed by the engines of such an aircraft each delivering a takeoff thrust of the order of 1500 kN equivalent to approximately 20000 kW, but this latter power only relates to the maximum thrust value, which is only implemented by the aircraft for takeoff or go-around phases.

When an aircraft is in cruise, because of its speed and altitude, the thrust/power effectively used are very much lower than that of the takeoff

At only 10000 m of altitude, the atmospheric pressure is divided by an approximate factor of four and the thrust of the engine is reduced, resulting in the aforementioned example in an equivalent power of the order of 3000 kW, the power of the thermoacoustic engine being unchanged as already stated.

In these operating conditions, the power that can be supplied to the thermodynamic turbine engine 20 by the thermoacoustic engine 50 is not negligible since it represents more than 10%, approximately 15% of this, on which proportion, the hybrid generator 100 benefits from the gain in output from the thermoacoustic generator 50 and electric motor 30.

Advantageously, the thermoacoustic generator 50 will be designed to deliver a useful power equal to or less than 50% of the power of the hybrid generator 100 in an average continuous operating regime of the thermodynamic turbine engine 20.

This way, overdimensioning of the thermoacoustic generator 50 is avoided for the benefit of a possible distribution of the expected total power of the hybrid generator between the thermoacoustic generator and the thermodynamic turbine engine 20, the distribution being managed, for example, by a power or thrust management computer.

The advantage of the hybrid generator 100 is increased because, in a dimensioning process of the hybrid generator, the power assigned to the thermodynamic turbine engine 20 is reduced, compared with that of an engine as sole power generator, by that produced by the electric power source 40, which results in reducing the size and the mass of the engine and in increasing its reliability accordingly via a reduced demand

Furthermore, the thermoacoustic engine 50 can be implemented as independent onboard source of electricity. Because of this, it is capable of being a substitute for the auxiliary power units of aircraft, which are used, in particular, for starting the engines on the ground while supplying compressed air, at least for engines of more than 1000 kN takeoff thrust, and for supplying electricity to the aircraft when the engines are shut down. The implementation of the hybrid generator 100 thus makes it possible to avoid the installation of conventional auxiliary power units. This also and in a significant way improves the global reliability of the aircraft.

When the thermoacoustic engine 50 is used as independent source of electrical energy, it offers the superiority of not being a source of noise pollution like the turbine auxiliary power units.

Furthermore, because of the very architecture of the hybrid generator 100 and the electric power source 40 that the generator implements, an aircraft can be, in an autonomous manner, controlled to taxi on the ground by electric wheel motors or by an electric drive of a rotating engine body 20, for example of the large diameter compressor 24 (fan), and the engines can be electrically started by means of the electric motor 30 as late as possible, just before takeoff This solution makes it possible to limit noise pollution and pollution due to hydrocarbons around airport platforms.

In normal operation, i.e., apart from the event of a failure, the thermoacoustic engine(s) 50 of the electric power generator(s) 40 produce(s) electricity independently of the operation of the engines.

Thus, in the event of a failure of the engines, the production of electricity is not affected, which makes it possible to continue to supply the equipment of the aircraft, condition particularly critical on modern aircraft with totally electric flight controls, including if applicable the servo-controls if these have electric actuators. If an engine failure is of thermodynamic origin, it is still possible to drive the rotating portions of the engine 20, in particular those of the large diameter compressor (fan) 24, by means of an electric motor 30 and thus to maintain an engine thrust, which, even reduced, makes it possible to improve the apparent lift-drag ratio of the aircraft and substantially to increase its radius of action in the event of problems.

It should be noted here that, in contrast to aircraft of conventional architectures, which implement turbine auxiliary power units that are shut down in cruise and must be restarted so as once more to produce electrical energy essential to the aircraft, in the case of the hybrid generator 100, there is no interruption of the production of electricity or any risk of not restarting the auxiliary power unit, since the production of electricity by means of the thermoacoustic engine 50 is constant.

Regarding this last comparison between the conventional solutions and the hybrid generator of the invention, it should also be noted that the turbines of the auxiliary generators more often than not have a maximum in-flight restarting altitude, and if the aircraft is above this maximum altitude, the aircraft must initiate a descent with other means of generating electricity, batteries and/or wind turbines, until an altitude favorable for restarting the turbine of the auxiliary unit is reached.

The hybrid generator 100 therefore makes it possible to eliminate conventional auxiliary power units as well as electric generators that are mechanically driven by the engines, and this with improvements on mass, ease of installation and reliability.

The operational advantages of the hybrid generator 100 of the invention, in particular in the case of its use as a means of propulsion of an aircraft, are therefore evident.

Considering the aspect of the energy output of the hybrid generator 100 and that of the use of thermoacoustic engines 50 for producing electric power, the advantages of the invention are even more evident if the use of cryogenic fuel is considered, for example liquid methane at ambient pressure at a temperature of 111 K, solution today considered as a possible alternative to kerosene.

In this case, cryogenic methane can be used to form cold sources 60 at low temperature, of the order of 150 K, so as to improve the thermodynamic output of the thermoacoustic generators.

The reheated methane, in the cold sources of the thermoacoustic generators and/or in the compressor stages, in particular the high pressure compressors 221 of the thermodynamic turbine engines 20, whose output will also be improved by a reduction of the temperature before combustion, will advantageously be gasified so as to facilitate its implementation in the combustion zones, in particular those of the heat sources 70.

In an embodiment, the heat Q+ that must be supplied to the hot heat exchangers 57 is transported from the heat sources 70 to the exchangers by means of heat pipes or heat transfer fluid circuits, for example a metal in liquid state at the implemented temperatures.

The heat sources include for example burners supplied with kerosene, methane or another fuel.

In an embodiment, a quantity of heat not used in the thermodynamic turbine engine 20, for example as outlet from the turbines, is used to increase the temperature of the heat source 70.

A hybrid generator 100 can if need be achieved by combining one or more thermodynamic turbine engines with one or more electric power generators 40, for example because of installation constraints, unitary power constraints of the elements implemented or safety constraints.

In this case, the electrical energy produced by the electric generator(s) can be distributed to the thermodynamic turbine engine(s) in an evolving manner depending on operational conditions.

In an operational application implementing a set of hybrid generators 100, it is also possible to manage transfers of electric power among the different hybrid generators, for example in the context of reconfigurations in the event of failure.

The hybrid generator 100 thus provides an alternative to the solutions of hybrid power or thrust generators by introducing simultaneous electrical hybridization in operation to a thermodynamic turbine engine, whose energy is produced locally by high output electrical generation devices using the existing onboard resources and by providing permanent assistance to the conventional power or thrust generators for the benefit of reducing the maximum power values of the thermodynamic turbine engine, even a possible temporary substitution at least in a degraded mode.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-14. (canceled)

15. A hybrid power or thrust generator comprising:
at least one thermodynamic turbine engine, and
at least one electric power generator,
said at least one electric power generator being electrically connected to at least one electric motor,
said at least one electric motor being mechanically and rotably coupled to at least one rotating portion of said at least one thermodynamic turbine engine, and
said at least one electric power generator being in simultaneous operation with said at least one thermodynamic turbine engine to supply the at least one electric motor to reduce electric power drawn from at least one turbine of said thermodynamic turbine engine in operation.

16. The hybrid power or thrust generator as claimed in claim 15, wherein said at least one electric power generator includes at least one thermoacoustic engine driving a linear electric alternator.

17. The hybrid power or thrust generator as claimed in claim 16, wherein at least one cold source of said at least one thermoacoustic engine implements a fuel of a thermodynamic turbine engine.

18. The hybrid power or thrust generator as claimed in claim 16, wherein at least one cold source of said at least one thermoacoustic engine implements a fuel of a thermoacoustic engine.

19. The hybrid power or thrust generator as claimed in claim 17, wherein the fuel is a cryogenic fuel stored in a liquid state at a temperature lower than 120 K.

20. The hybrid power or thrust generator as claimed in claim 19, wherein the fuel is cryogenic liquid methane

21. The hybrid power or thrust generator as claimed in claim 16, wherein at least one heat source of said at least one thermoacoustic engine uses, for at least a portion of a quantity of heat supplied to one or more hot heat exchangers of said at least one thermoacoustic engine, combustion of a fuel that is also used to supply a thermodynamic turbine engine.

22. The hybrid power or thrust generator as claimed in claim 16, wherein at least one heat source of said at least one thermoacoustic engine uses, for at least a portion of a quantity of heat supplied to one or more hot heat exchangers of said thermoacoustic engine, a quantity of heat drawn from a thermodynamic turbine engine at a combustion chamber.

23. The hybrid power or thrust generator as claimed in claim 16, wherein at least one heat source of said at least one thermoacoustic engine uses, for at least a portion of a quantity of heat supplied to one or more hot heat exchangers of said thermoacoustic engine, a quantity of heat drawn from a thermodynamic turbine engine at turbine stages.

24. The hybrid power or thrust generator as claimed in claim 15, wherein the at least one electric power generator is dimensioned to deliver electric power equal to or greater than 10% of a thermodynamic power of a continuous operating rpm in service of said at least one thermodynamic turbine engine of the hybrid power or thrust generator.

25. The hybrid power or thrust generator as claimed in claim 24, wherein the at least one electric power generator is dimensioned to deliver electric power less than or equal to a thermodynamic power of a continuous operating rpm in service of said at least one thermodynamic turbine engine of the hybrid power or thrust generator.

26. The hybrid power or thrust generator as claimed in claim 15, wherein the thermodynamic turbine engine is a turbojet.

27. The hybrid power or thrust generator as claimed in claim 15, wherein the thermodynamic turbine engine is a turboprop unit.

28. A vehicle including at least one hybrid power or thrust generator as claimed in claim 15, implemented as a main propulsion device.

29. The vehicle as claimed in claim 28, wherein the at least one electric power generator of the at least one hybrid power or thrust generator is implemented as a main source of electrical energy of equipment of said vehicle.

30. The vehicle as claimed in claim 28 including at least two hybrid power or thrust generators, and wherein the use of at least one electric power generator of each of said at least two hybrid power or thrust generators is configured, through reconfigurations of a system of distribution of electrical energy produced by said at least one electric power generator of each hybrid power or thrust generator, to be switched towards one or other of the at least one thermodynamic turbine engines of each of said hybrid power or thrust generators, the switching affecting all or some of the electric power.

31. The vehicle as claimed in claim 28, wherein said vehicle is an aircraft.

32. The vehicle as claimed in claim 31, wherein the electric power generator of each of the hybrid power or thrust generators includes a thermoacoustic engine installed in a fuselage of the aircraft.

33. The vehicle as claimed in claim 31, wherein the electric power generator of each of the hybrid power or thrust generators includes a thermoacoustic engine installed in wings of said aircraft.

34. The vehicle as claimed in claim 31, wherein the electric power generator of each of the hybrid power or thrust generators includes a thermoacoustic engine installed in streamlined spaces of a structure of said aircraft.
